(19) United States
(12) Patent Application Publication
(10) Pub. No.: US 2017/0071044 A1
(43) Pub. Date: Mar. 9, 2017

(54) METHOD AND SYSTEM FOR PROVIDING HORTICULTURAL LIGHT TO PLANTS

(71) Applicant: VALOYA OY, Helsinki (FI)

(72) Inventor: Lars AIKALA, Lapinkyla (FI)

(21) Appl. No.: 14/879,435

(22) Filed: Oct. 9, 2015

Related U.S. Application Data
(60) Provisional application No. 62/215,206, filed on Sep. 8, 2015.

(51) Int. Cl. H05B 33/08; A01G 9/26; A01G 7/04; A01G 1/00; A01G 9/20

(52) U.S. Cl. CPC H05B 33/0863; A01G 1/001; A01G 9/20; A01G 7/045; A01G 9/26

(57) ABSTRACT

The present invention discloses a method and system for providing horticultural light to a plant. The said method and system includes at least one computer, at least one database, a communication network and a horticultural light emitting diode (LED) array configured to provide light to plants. The user provides an input to the computer and said computer accesses the databases to identify an outdoor light spectrum corresponding to the said input. Further, the said computer determines LED instruction parameters corresponding to the identified outdoor light spectrum and communicates the identified LED instruction parameters to the horticultural LED array. The horticultural LED array receives said instruction parameters and produces emission corresponding to the said outdoor light spectrum. The said outdoor light spectrum produced by the said horticultural LED array shines on at least one plant that corresponds to the selected user inputs.

### FIELD OF THE DISCLOSURE

The present invention relates to a method and a system for providing horticultural light to plants. More specifically, the invention relates to a programmed and computer controlled system that helps in providing the appropriate light to at least one plant as per the light spectrum preferred for the said plant.

### BACKGROUND OF THE DISCLOSURE

The rapid industrialization and rapid growth of the human population has increased the overall demand for the food. On the other hand, climate change has also effected the overall food production and hence nowadays farmers are utilizing controlled environmental conditions for growing a desired plant. Accordingly, while growing a plant in a closed environment conditions, there is always a demand for providing an artificial light to the plant. The use of artificial lighting for horticulture has generated a number of benefits to the horticulture industry, including increased yields, better control of plant growth, faster germination, and the like.

Artificial lighting as a replacement for natural sunlight depends upon various factors such as geographical conditions for the development of various plants, increasing scarcity of agricultural land, the natural light spectra utilized by the plant and other factors. The natural light spectra utilized by various plants typically falls in the wavelength region of around 300 nanometre (nm) to 800 nm of the electromagnetic spectrum. This fact is utilized in implementing the use of artificial sunlight in horticulture by emission of said wavelength of light by various sources.

Solid state LED lighting, as a light source, has been a great advantage over conventional incandescent and fluorescent lamps. LED lighting being highly energy-efficient, helping horticultural producers to lower electricity consumption, especially during the high consumption periods of autumn and winter. The use of LEDs in horticulture has helped to increase production, utilize space, reduce energy consumption and most importantly grow plants in foreign climatic conditions, for example in greenhouses in Scandinavia.

One such system and method has been disclosed in U.S. Pat. No. 8,549,787 (hereinafter referred as '787 patent). In this U.S. patent '787, a lighting fixture for facilitating plant growth and a light emitting component is disclosed. The U.S. patent '787 discloses about the utilization of LED light as a lighting assembly for facilitating plant growth. The said patent discloses various spectral ranges for the growth of plants. This document is cited here as reference.

Further, another patent application (WIPO publication number 2012/123627 A1) discloses a plant illumination device and method. This patent application also focuses on improving the performance of the LED chip. This document is cited here as reference.

Furthermore, another patent application (WIPO publication number WO 2014/013400 A2) discloses a method for providing horticultural light to a crop, and lighting device for horticulture lighting. This patent application discloses a LED array that is computer controlled. This document is cited here as reference.

EP2604094 discloses a method where a sensor e.g. on the wall of a house in the outdoors is used to measure light, and the same light is repeated inside the house by a semiconductor light. This document is cited here as reference.

Quite clearly the prior art technology is still quite time and space constrained, and requires a lot of special attention and understanding from the farmer who may or may not have sufficient expertise available. The invention is designed to alleviate these disadvantages.

### SUMMARY

Accordingly, there is a need for a system and method adapted for providing suitable artificial outdoor light spectra to meet the different demands of the plants and their farmers.

Further, there is a need to use the knowledge of successful geographical growth conditions of plants and to automatically generate corresponding conditions for growing a plant in a closed environment.

Furthermore, there is a need for a system and a method adapted to take input from a user who wants to grow plants from different climatic conditions and the said system provides horticultural light to the plant(s) corresponding to the user input.

Aspects of the invention are thus directed to a method and system for creating an artificial outdoor light, environment and climate for growing the plants in a closed environment. The present method and system utilizes the environmental knowledge and other agricultural data as required for growing a particular plant in a particular geographical condition. The collected environmental knowledge and data is provided to a computer, whereas the said computer generates a response signal corresponding to the said knowledge and data. The said response signal executes various functions such as illuminating the LED lights on the plants, watering and adding nutrition to the plants.

It is another object of the present invention to provide a method and system for generating artificial horticulture light over a plant as per the natural light conditions of that plant in its natural habitat. The present method and system utilizes data related to the natural light spectrum of a plant and thereby provides a corresponding or same light spectrum in the artificial light conditions.

It is another object of the present invention to reduce the farmer's efforts to select a particular light spectrum at a particular time interval while growing a plant in a closed environment such as a multi-story greenhouse. The farmer provides an input to a computer, wherein, the said input is one of a plurality of agricultural attributes related to a plant. Based on the farmer's input the computer executes a plurality of functions such as LED grid illumination, reproducing natural conditions in the artificial growth environment for that plant based on farmer instructions.

It is another object of the present invention to provide a method and system for automatically providing the necessary water and nutrients based on the natural water and mineral demand of that plant.

A method of the invention for providing horticultural light to a plant is, comprising at least one computer, at least one database, a communication network and a horticultural light emitting diode (LED) array configured to provide light to plants is characterised by the steps of:

user defines at least one attribute to at least one computer;

at least one computer accesses the database to identify an outdoor light spectrum corresponding to the said attributes;

at least one computer determines LED instruction parameters corresponding to the identified outdoor light spectrum;

at least one computer communicates the said LED instruction parameters to the horticultural LED array;

the horticultural LED array receives said instruction parameters and produces emission corresponding to the said outdoor light spectrum;

the said outdoor light spectrum produced by the said horticultural LED array shines on at least one plant.

A system of the invention for providing horticultural light to a plant comprises:

at least one computer having a user interface with which a user is arranged to define at least one attribute to the at least one computer;

at least one database accessible by the said at least one computer, the at least one computer is configured to identify an outdoor light spectrum corresponding to the said plurality of attributes as defined by the user;

an instruction module having a plurality of light emitting diode (LED) instruction parameters corresponding to the identified outdoor light spectrum, and the at least one computer is configured to select the said LED instruction parameters;

a horticultural light emitting diode (LED) array configured to provide light to at least one plant,

the horticultural LED array is configured to receive said LED instruction parameters and produce emission corresponding the said outdoor light spectrum, wherein the said horticultural LED array is configured to shine light on at least one plant and the spectrum of the light is configured as the said outdoor light spectrum.

A software program product in accordance with the invention is adapted to execute a method in a system, the said software program product being configured to control horticultural light administered to a plant by the steps of:

user provides an input to at least one computer;

accessing at least one database having at least one predefined outdoor light spectra, and/or algorithms for producing at least one outdoor light spectra, via a computer;

comparing the said input with the plurality of predefined or derived outdoor light spectra;

identifying at least one of predefined or derived outdoor light spectrum, the said spectrum corresponds to spectrum derived based on the input of the user;

selecting a plurality of light emitting diode (LED) instruction parameters,

the said LED instruction parameters being configured to produce a corresponding emission spectrum to the identified outdoor light spectrum;

transmitting the said LED instruction parameters to a horticultural light emitting diode (LED) array;

producing emission from the horticultural LED array based on the received LED instruction parameters, the said emission correspond to the said outdoor light spectrum.

In one embodiment of the present invention, the method and system provides an automated system for growing at least one plant in a closed, dark growth chamber, under a computer controlled environment.

According to another embodiment of the present invention, the farmer's efforts are reduced by the use of the present invention as the system is capable of monitoring and controlling various climatic conditions, and preferably have the conditions match those of the natural growth environment of the plant.

According to another embodiment of the present invention, the method and system generates an artificial light spectrum at a particular time interval while growing a plant in a closed environment. The present system is user friendly, providing a user interface (UI) to input and based on the said input, the system executes a plurality of functions such as LED grid illumination as per the natural conditions of that plant. For example, the farmer might be operating the growth chamber in Finland, but in the winter, but he could be planting pineapple in the growth chamber. The farmer could then select Hawaiian summer natural outdoor light for his pineapples from the computer system. The farmer could also select the time of day for the simulated outdoor light, e.g. by selecting noon, the system would produce LED light that would correspond to the Hawaiian summer outdoor light at 12 o'clock noon. Similarly watering could be adjusted by selecting watering equivalent to rainfall during the Hawaiian summer.

According to an embodiment of the present invention, the method and system automatically provides the necessary water and nutrients as per the demand of a plant in natural conditions.

According to an embodiment of the present invention, the method and system automatically generates at least one outdoor light spectrum as preferred by various insect species in a natural environment. For example, suppose the farmer is farming arctic cloudberries in Saudi Arabia. Therefore the computer will select arctic summer outdoor light spectrum from the database, and control the LEDs to produce such a spectrum and intensity. Further, watering and mineralisation of the cloudberry plants may be adjusted to be similar to that of the arctic swamps. Even further, as is well known, the flower of the cloudberry plant is light yellow/white, and the cloudberry plant is insect pollinated. Suppose the farmer has bees in his growth chamber. Therefore the farmer will select “enhance bee pollination” from the computer menu and the computer system will add an intensity peak of light yellow color, matching the color of best reflectance from the cloudberry plant. Additionally or alternatively, the computer system may also add an emission peak into the spectrum emitted by the LEDs to the wavelength of maximum bee eye sensitivity. This will provide the growth chamber with light that the bees can readily use, which should lead to improved pollination outcomes.

The best mode for practicing the invention is considered to be the growth of foreign and exotic insect pollinated plants at the geography of consumption in a completely dark growth chamber, to match already established consumer tastes for the foreign exotic plants. The best mode system operates as a computer cloud network that is designed to access the latest information pertaining to natural outdoor light and other growth factors such as watering and minerals from a database or a plurality of different databases or other electronic data sources. In the best mode, the farmer simply puts the plants in a dark growth chamber with LEDs and plugs the growth chamber on to computer, establishing a connection for the computerized control of the LEDs via wireless or wireline communication. The farmer then enters data in the form that is recognizable to the farmer to the computer system. For example, the farmer may input that the plants in the growth chamber are cloudberries, the pollinators are bees, and the berries need to be grown as if they were in Ranua, Finland (a famous destination known for cloudberry harvests). The computers system will calculate a day-to-day regime of artificially generated natural outdoor light dose, by taking into account the air column thickness from Ranua to space, weather phenomena, atmosphere composition, time of year, time of day and so forth, and the computer system will generate a spectral model corresponding to natural outdoor light under the aforementioned conditions, and further generate instructions to drive the LEDs to produce the light spectrum corresponding to the natural outdoor light spectral model in the dark growth chamber. Further the computer system may modify the spectral model to enhance pollination by the bees efficiently, adding an emission peak at the reflectance wavelength of the flowers of the cloudberry plants, and/or adding an emission peak at the maximum sensitivity wavelength of the insect eye, bee eye, in this case. Optionally the computer system will calculate a watering regime from humidity, geological data and rainfall data and a mineralization regime for geological data applicable to the said geographical location, Ranua. The best mode allows for example a farmer in Saudi-Arabia to produce cloudberries in a basement in Saudi-Arabia without any scientific knowledge about cloudberries or farming. The farmer simply specifies how he wants to grow the cloudberries in comparative terms, i.e. “similarly as in Ranua”, and the computer or the computer network searches and accesses the necessary data from the information networks, extracts the growth attributes in quantitative, scientific mathematical terms, and generates the computer instructions that operate the LEDs and optionally watering and mineralization devices to replicate the growth conditions in the growth chamber to those of Ranua, Finland.

The invention has a plurality of advantages. The invention allows farmers to convert their everyday knowledge into actionable scientific and quantitative plant growth data that can be used to generate known preferential plant growth conditions from a specific geography to a dark growth or a greenhouse anywhere in the world.

### DESCRIPTION OF THE DRAWINGS

The advantages and features of the present invention will become better understood with reference to the following detailed description taken in conjunction with the accompanying drawings, in which:

FIG. 1 illustrates a system embodiment 10 as a block diagram of the present invention;

FIGS. 1a and 1b illustrate an exemplary user interface (UI) embodiments 20 and 30 of a computer, according to the present invention;

FIG. 2 illustrates an embodiment 40, showing various steps for the functioning of the inventive method of the present invention as a flow chart;

FIG. 3 illustrates an exemplary method embodiment 50 as a flowchart for setting up cloudberries for growth with arctic sunlight, in accordance with the present invention.

FIG. 4 illustrates an embodiment 60 of a system as a block diagram for cultivation of “cloudberries” in “arctic sunlight”, in accordance with the present invention.

FIG. 5 illustrates an exemplary method embodiment 70 as a flowchart for setting up pineapple for growth with equatorial pacific sunlight, according to the present invention.

FIG. 6 illustrates an exemplary system embodiment 80 as a block diagram for cultivation of “pineapple” in “equatorial pacific sunlight”, according to the present invention.

FIG. 7 illustrates an exemplary method embodiment 90 as a flowchart for setting up farm cocoa for growth with natural light from Ghana, according to various embodiments of the present invention.

FIG. 8 illustrates an exemplary system embodiment 91 as a block diagram for cultivation of “farm cocoa” in “natural light from Ghana”, according to the present invention.

FIG. 9 illustrates an exemplary embodiment 92 of an artificial spectrum graph depicting intensity of electromagnetic spectrum versus wavelength, according to the present invention.

FIG. 9b illustrates an exemplary embodiment 93 of an artificial spectrum graph showing how an artificial outdoor spectrum with added spectral components is derived in accordance with the invention.

Like reference numerals refer to like parts throughout the description of several views of the drawing.

Some of the embodiments are described in the dependent claims.

### DESCRIPTION OF THE INVENTION

Unless otherwise specified, the terms, which are used in the specification and claims, have the meanings commonly used in the field LED lighting used in horticulture, as well as in the field of computers.

Unless otherwise specified, the terms “user” and “farmer” are used interchangeably hereinafter.

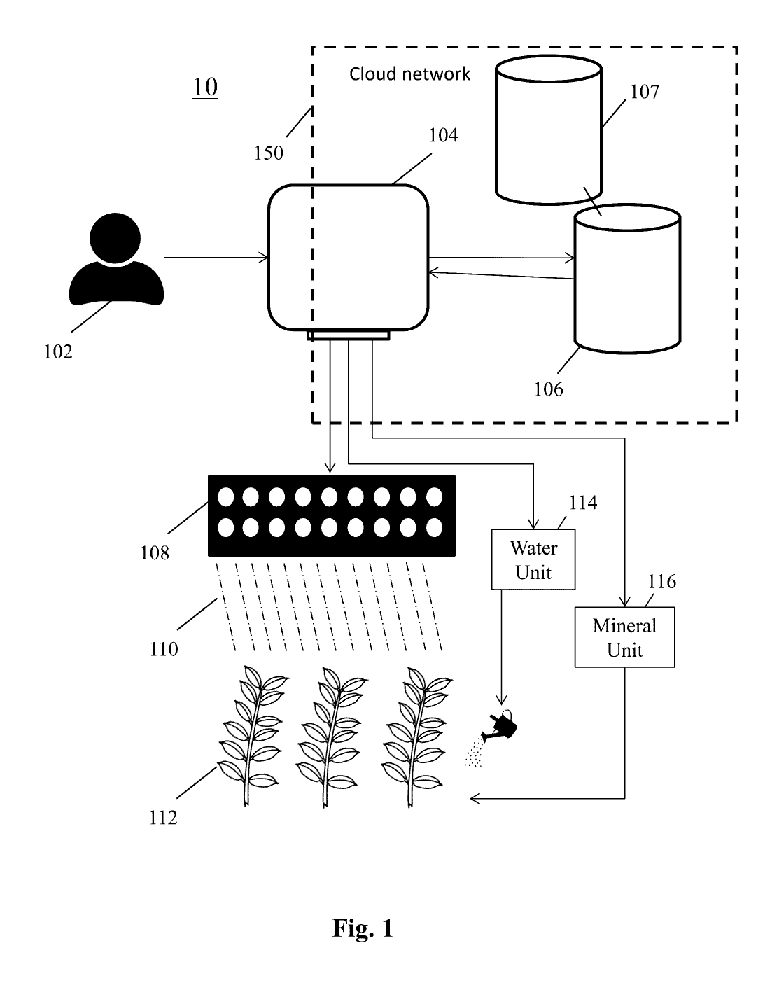

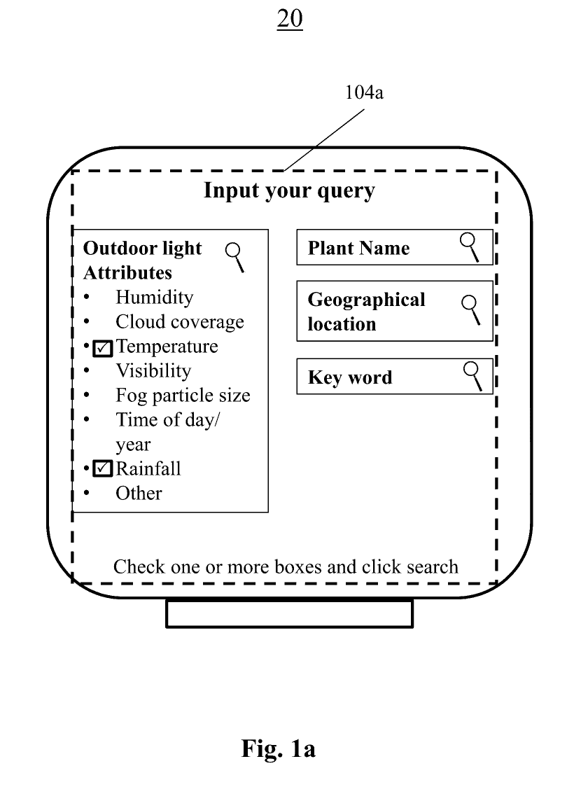

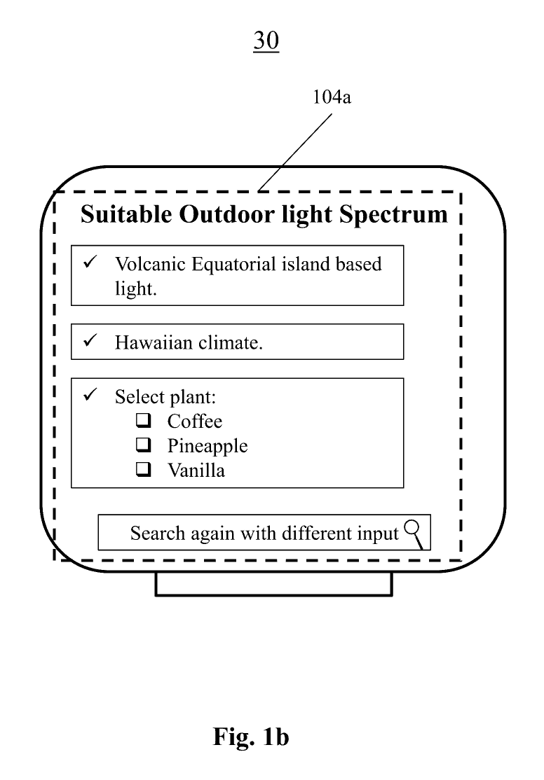

The present invention relates to a method and a system and a software program product for providing horticultural light to plants. FIG. 1 illustrates a block diagram of embodiment 10 wherein a system provides horticultural light 110 to a plurality of plants 112. The system 102 is used by a user 102 who inputs at least one attribute, typically a plurality of attributes to a computer 104. The computer is typically a PC (Personal Computer) or mobile computer, such as a tablet or a mobile phone, such as a smartphone.

In one embodiment of the present invention, input from the user 102 includes at least one of a plurality of plant attributes. The attributes include but are not limited to any of the following: plant name, at least one geographical location of a plant, and/or at least one pollinating insect species, among others.

The input attributes may also involve outdoor light attributes. The plurality of outdoor light attributes may include but is not limited to air humidity, cloud coverage, temperature, rainfall, visibility, fog particle size, time of day, time of year, celestial mechanical condition at the location of the plant or a combination thereof. These outdoor light attributes contribute to defining the model of the outdoor light for a particular plant in a particular location on Earth at a particular time.

For example, suppose the user inputs, location Hawaii, temperature between 22-29° C. year round, with about 50 mm/month of rain. These attributes correspond approximately to Hawaiian climate, which is good for the growth of coffee.

Based on inputting the above outdoor light attributes to the computer 104, the system 100 generates Volcanic Equatorial Island based light or the light corresponding to outdoor light from Hawaii to accommodate the growth of plants like coffee, pineapple, vanilla etc.

Further, input from the user 102 may include, a plant name, keyword, plant type, a geographical location or a combination thereof. This feature of the present invention enables a person who is not versed with farming conditions and/or has no knowledge of the atmospheric chemistry, or of a particular plant, to input a plant name into the computer 104, and the system 100 presents the user 102 with at least one identified outdoor light spectrum corresponding to his input. For example, suppose a farmer wants to grow “cocoa” which comes from “Ghana”, then in this situation the farmer will simply input the plant name as “cocoa” and geographical location as “Ghana” and the system presents the corresponding identified outdoor light spectrum.

When the computer 104 receives input from the user 102, it compares the input with the outdoor light spectra and/or other data stored in at least one database 106, 107 or provides the input parameters to the cloud server network 150 for processing. Typically the computer is connected to a computer cloud network that is continuously updated and maintained with the latest agricultural data, atmospheric data and geological data, as well as astronomical data. There may be a plurality of databases 106, 107 and/or server computers connected to the system, and also hosted in the cloud network. The computer cloud network may be realized over a wireline or wireless packet switched communication network. In some embodiments the computer cloud network is realized over the Internet, in some embodiments the cloud network is realized as a VPN (Virtual Private Network), and/or in some embodiments the cloud network is realized as a hosted service from any of the global cloud service providers such as Microsoft, Amazon or the like.

In one embodiment of the present invention, the database 106 comprises a HITRAN database, or contains data from HITRAN. HITRAN, an acronym for High Resolution Transmission is a compilation of spectroscopic parameters that a variety of computer codes use to predict and simulate the transmission and emission of light in gaseous media including the atmosphere, laboratory cells, etc. (please see Hitran at cfa.harvard.edu for details.)

The database 106 is a data repository containing different various light spectra, or data, models and algorithms to derive such spectra, for plants according to multiple criteria, including but not limited to, geographical location, rainfall, sunlight, air humidity, cloud coverage, temperature, visibility, fog particle size, time of day, time of year, celestial mechanical condition etc. Primarily the database 106 is configured to produce natural outdoor light spectra, so that the natural outdoor light at a certain outdoor location on Earth can be reproduced at another location, e.g. a dark growth chamber. However, in some embodiments the inventive system and method can also be used to generate light with a spectrum that is artificial and different to spectra observable in natural solar light. The database may store different libraries of spectra and/or it may comprise software and algorithms for computing different light spectra based input parameters, default parameters, or parameters retrieved via computerized search that may be automatic or user initiated.

Corresponding to each outdoor light spectrum in the database 106 there is at least one LED instruction or a set of instructions for the LED array 108. So, according to FIG. 1 when an input is received from the user 102, an outdoor light spectrum corresponding to the said input is identified and retrieved from the database 106. Corresponding to this identified spectrum, at least one LED instruction parameter is generated. The LED instruction parameters are then communicated to the LED array 108. The horticultural light 110 is emitted on at least one plant 112 from the LED array 108. The LED array comprises at least one LED, typically a plurality of LEDs of different colors. The LEDs may also be configured with wavelength altering phosphors, e.g. up-converting phosphors, thereby creating different emission wavelengths further still. Typically there is one phosphor that up-converts blue light to red light. Any of the LEDs mentioned in references of the inventor are hereby incorporated into this description as possible alternatives for LEDs in the inventive system implementation, please see references section.

The user input may also be scheduled or generated automatically based on a time set by the user 102. For example, the user 102 configures the input to be inputted after a period of 2 months, then the input is provided to the computer 104 after the said time period. With the invention, it is possible for the user to program the inputs as a function of time. The user could program a illumination regime similar e.g. to “Hawaiian spring”, and set the duration for 90 days, and then the system would produce natural outdoor light corresponding to light in Hawaii between approximately 1^{st} March to May 30^{th}, so that on the 1^{st} day of the illumination regime the LEDs provide light corresponding to 1^{st} March, on the 2^{nd} day light corresponding to 2^{nd} March and so on. In some embodiments of the invention it is possible to skip the nights entirely, and have the LEDs provide artificially generated natural outdoor light all the time.

In one embodiment of the present invention, the computer 104 determines watering and mineral uptake of a plant 112 based on the attributes provided by the farmer or based on data available in the computer network. Thereafter, the said computer 104 generates a control signal corresponding to the said attributes. The said control signal is transmitted to the watering 114 and mineral disposing units 116 of the system. The watering unit 114 is typically a tank of water or a water tap that is configured with a computer controlled switch to control the watering dose. The mineral disposing unit 116 is typically a tank of minerals with a computer controlled switch to control the mineralization dose.

The said watering 114 and mineral disposing units 116 may provide water and mineralization based on any of the following: rainfall and mineral content typical to the specified geographic location, and/or the natural demand of the plant, if this information is documented in any of the databases accessible to the inventive computer system.

It is also possible that the method and system automatically generates at least one outdoor light spectrum as preferred by various insect species for maximum insect pollination in a natural environment. Alternatively, the method and system can also generate spectral components that are artificial, and would not exist in natural light conditions, but which are known to enhance pollination activity with certain insects. These spectral components can be set to emit at for example the maximum reflectance of the flower of the plant being grown or at the insect eye sensitivity maximum of the insect species doing the pollination.

It should be noted that any features of the embodiment 10 may be readily combined or permuted with any of the embodiments 20, 30, 40, 50, 60, 70, 80, 90, 91, 92 and/or 93 in accordance with the invention.

According to embodiment 20 of the present invention, FIG. 1a illustrates various types of input. The user interface (UI) 104a of computer 104 as illustrated in FIG. 1a contains various options. For a person with knowledge of type of environment a plant needs, he can simply choose the option of “Outdoor light attributes” from the UI 104a.

As illustrated in FIG. 1a, the input can be a plant name. The input in form of “plant name” helps a person who is unaware of the climatic conditions of a plant he wants to grow; “plant name” instructs the computer 104 and the UI 104a is efficient and friendly enough to present outdoor light spectrum corresponding to input. Like in the example mentioned above where the user 102 provides the temperature and rainfall ranges, instead the user 102 can simply type in “coffee” as “plant name” and hit search. The UI 104a would present the similar outdoor light spectrum as illustrated in FIG. 1b.

According to yet another embodiment of the present invention, the user 102 has the option to input “keywords” as illustrated in FIG. 1a. For example, the user 102 can type in scientific name of a plant he wishes to grow. Say a user inputs “Coffee” as “plant name” in the UI 104a, the computer 104 gives the results similar to as illustrated in FIG. 1b.

It should be noted that any features of the embodiment 20 may be readily combined or permuted with any of the embodiments 10, 30, 40, 50, 60, 70, 80, 90, 91, 92 and/or 93 in accordance with the invention.

An embodiment 30 of the User Interface 104a of computer 104 as illustrated in FIG. 1b not only presents light spectrum for the said input, namely “volcanic equatorial island based light”, but for further convenience presents specific climate type according to region, namely “Hawaiian” and also according to plants, namely “coffee” that prefer temperature and rainfall in the said input range.

Under the “Outdoor light attributes” section, there are different attributes a user 102 can choose from. As an exemplary embodiment in FIG. 1a, “temperature” and “rainfall” are selected. If a user 102 clicks search then the computer 104 compares the said input with a list of outdoor light spectrum stored in the database 106 and upon identifying a suitable spectrum presents it to user 102, as illustrated in FIG. 1b.

For example, the user 102 selects a temperature range of 22-29° C. (59-75° F.) year round with 50 mm/month of rain and clicks search. Upon comparing the input with spectrums stored in the database 106, the computer 104 identifies and retrieves one or more suitable spectra for the user input. As illustrated in FIG. 1b, based on the input, the computer 104 presents an outdoor light spectrum. Based on the temperature and rainfall range input by the user 102, the computer 104 presents “Volcanic Equatorial island based light”, seeing as this type of geographical location has both temperature and rainfall in the said range. More specifically, “Hawaiian climate” or plants like “coffee, pineapple, vanilla” and the like prefer the said temperature and rainfall range.

It should be noted that any features of the embodiment 30 may be readily combined or permuted with any of the embodiments 10, 20, 40, 50, 60, 70, 80, 90, 91, 92 and/or 93 in accordance with the invention.

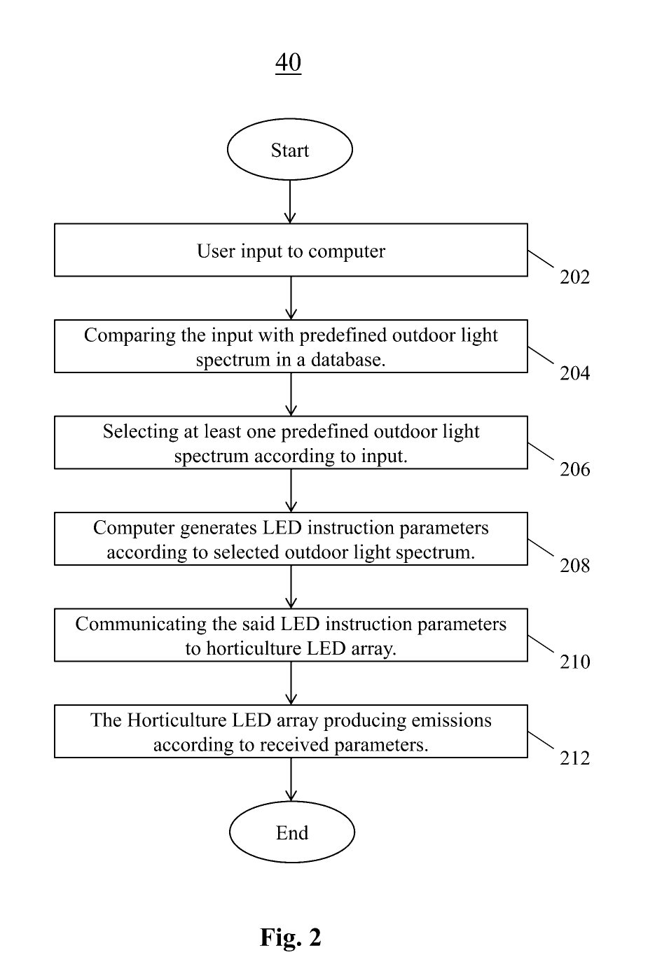

FIG. 2 illustrates an embodiment 40 of a method as a flowchart showing various steps for the functioning of the present invention. The method 200 starts when user 102 at 202 inputs outdoor light attributes or plant name or geographical location or a combination thereof, to a computer. The input of user 102 determines the horticultural light emission 110 on a plurality of plants 112.

On receiving the input from step 202, the computer 104 compares the input with a list of outdoor light spectrum stored in the database 106 or derives a model outdoor light spectrum with a mathematical algorithm or computer program based upon the input parameters. The database 106 includes at least one outdoor light spectrum or at least one model for generating such a spectrum. Upon identifying or producing a suitable outdoor light spectrum from the database, the computer 104 at step 206 selects the identified spectrum.

At step 208, the computer 104 generates LED instructions parameters based on the identified outdoor light spectrum. These instructions are typically computer code or current signals configured to power certain LEDs with certain intensity for a certain time and so on. The said parameters are then communicated to the LED array 108 at step 210 via a wireline or a wireless communication connection. Out in the Field a LED Array might have a cellular modem card installed for receiving data for example. Upon receiving the parameters, the LED array 108 executes the instructions at step 212 and emits light 110 on at least one plant 112. These emissions and/or horticultural light 112 is hence directly dependent on the user input or the type of light the user 102 wants for his plants 112.

It should be noted that any features of the embodiment 40 may be readily combined or permuted with any of the embodiments 10, 20, 30, 50, 60, 70, 80, 90, 91, 92 and/or 93 in accordance with the invention.

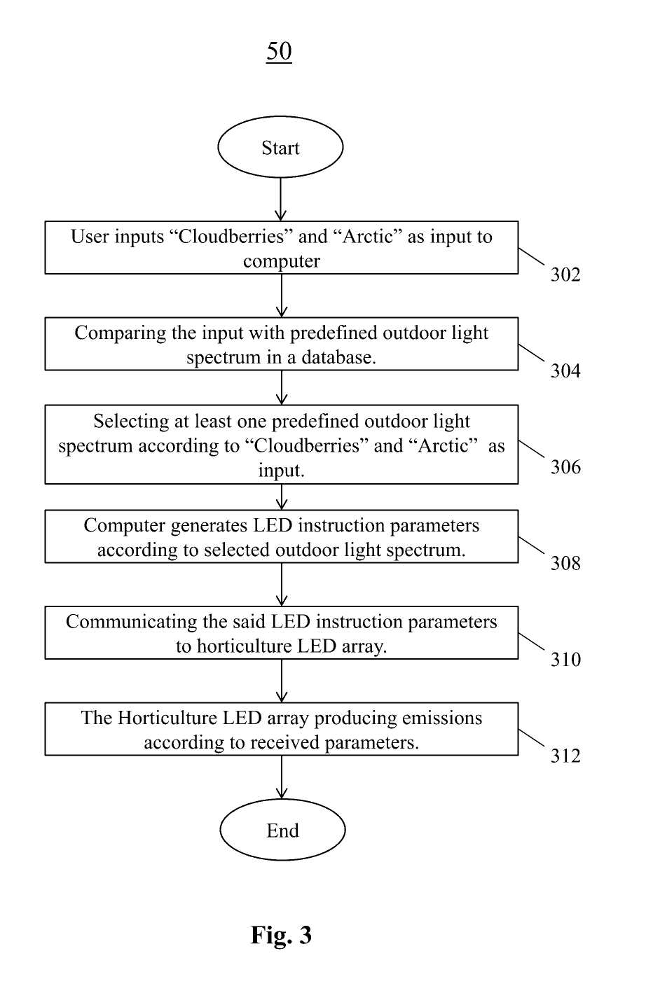

FIG. 3 illustrates an exemplary embodiment 50 as a flowchart for setting up cloudberries for growth with arctic sunlight, according to various embodiments of the present invention. The steps as mentioned in the description of FIG. 2 are executed with plant name and location being “cloudberries” and “arctic” respectively. The plant specific data utilized now relates to the cloudberry plants. The atmospheric data relates now to the arctic regions, i.e. thick air columns at the poles of the Earth and moderate temperatures.

It should be noted that any features of the embodiment 50 may be readily combined or permuted with any of the embodiments 10, 20, 30, 40, 60, 70, 80, 90, 91, 92 and/or 93 in accordance with the invention.

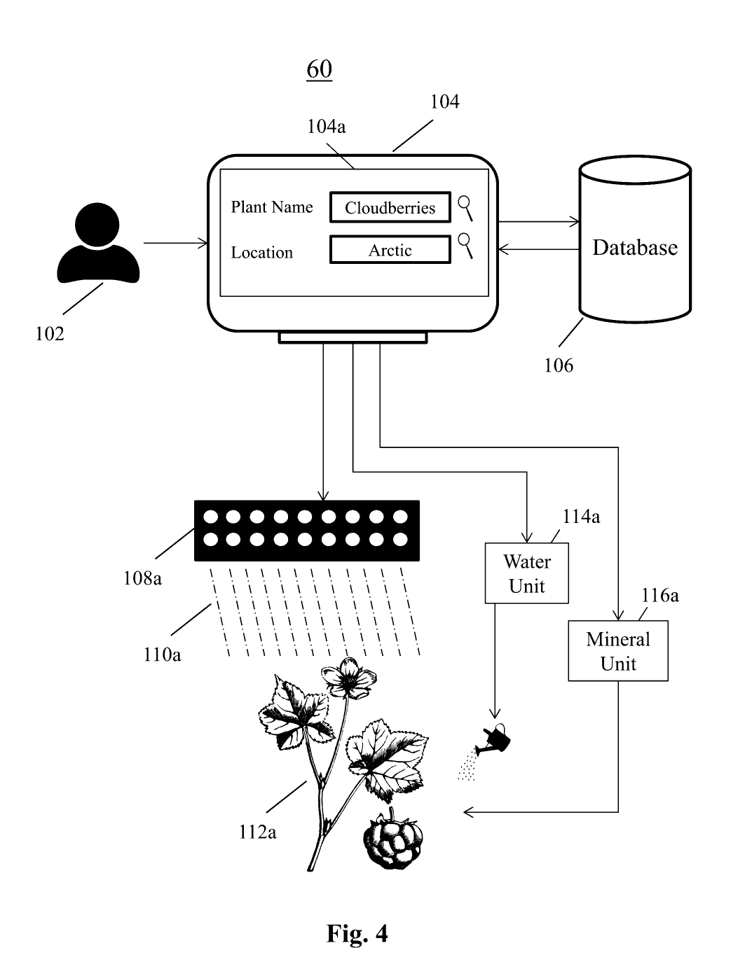

FIG. 4 illustrates an exemplary embodiment 60 of a system and method for emission of horticultural light on a plurality of plants based on plant name and/or geographical location. Say a user 102 wants to grow cloudberries 112a but does not know the right atmospheric chemical conditions required for its growth; the user 102 with the help of various input ways as also described in FIG. 1a can choose to input only “plant name” in UI 104a of computer 104. When the user 102 inputs plant name as “cloudberries” and runs a search, the computer 104 compares the input with different outdoor light spectrum stored in the database 106 or generates a model outdoor spectrum based upon the inputted attributes. The system setup of FIG. 4 relates to the method of FIG. 3.

Now as described in the description of FIG. 1b above, the computer 104 returns with result showing “arctic sunlight” as the outdoor light spectrum. The system and method 100 is efficient enough to know that “cloudberries” require “arctic sunlight” and identifies this light spectrum as the best match for the user input.

Consecutively, upon selection, either automatically or by user, of the said outdoor light spectrum, the computer 104 generates LED instruction parameters for the LED array 108a. The array 108a upon receiving the instructions from the computer 104 produces the horticultural light 110a on “cloudberries” plant 112a.

It should be noted that any features of the embodiment 60 may be readily combined or permuted with any of the embodiments 10, 20, 30, 40, 50, 70, 80, 90, 91, 92 and/or 93 in accordance with the invention.

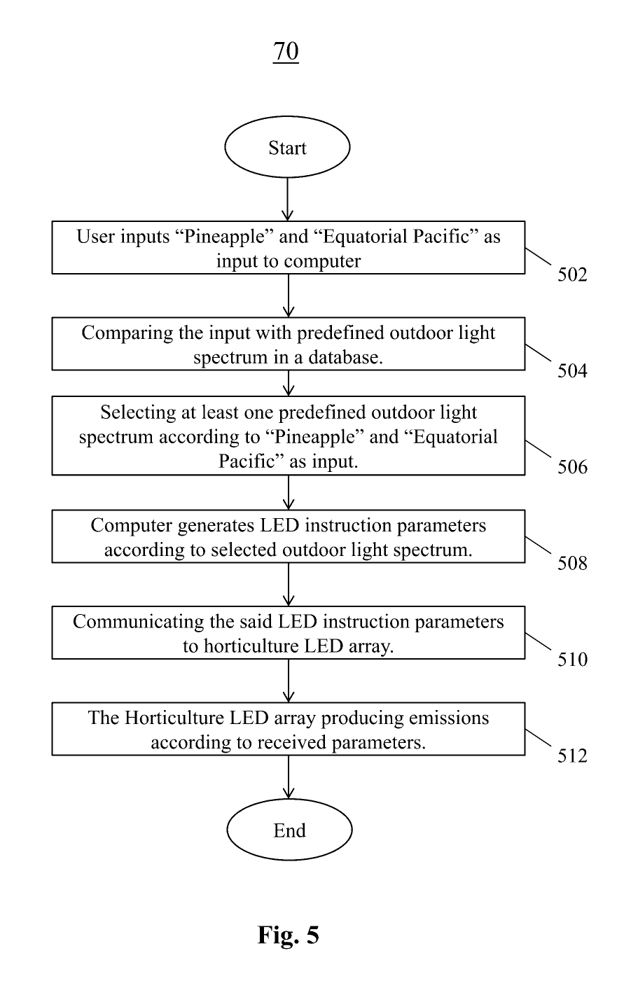

FIG. 5 illustrates an exemplary embodiment 70 as a flowchart for setting up pineapple for growth with equatorial pacific sunlight, according to various embodiments of the present invention. The steps as mentioned in the description of FIG. 2 are executed with plant name and location being “pineapple” and “equatorial pacific” respectively. The plant specific data utilized now relates to the pineapple plants. The atmospheric data relates now to the equatorial regions, i.e. thin air columns at the equator of the Earth during noon especially and mild to warm tropical maritime temperatures.

It should be noted that any features of the embodiment 70 may be readily combined or permuted with any of the embodiments 10, 20, 30, 40, 50, 60, 80, 90, 91, 92 and/or 93 in accordance with the invention.

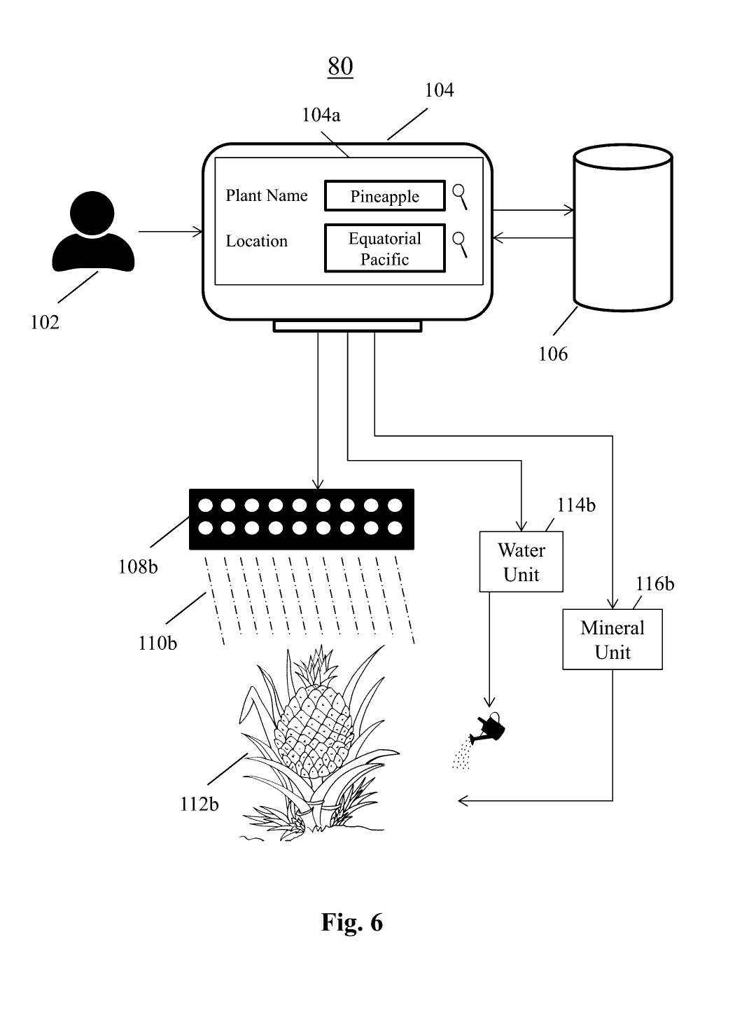

In the embodiment 80 of the present invention, as illustrated in FIG. 6 if the user 102 types in UI 104a, plant name as “pineapple” and mentions location as “equatorial pacific sunlight”, the computer 104 upon finding the suitable outdoor light spectrum, or deriving one, commands the LED array 108b to provide plant 112b with “equatorial pacific sunlight” as horticulture light 110b. The system setup of FIG. 6 relates to the method of FIG. 5.

It should be noted that any features of the embodiment 80 may be readily combined or permuted with any of the embodiments 10, 20, 30, 40, 50, 60, 70, 90, 91, 92 and/or 93 in accordance with the invention.

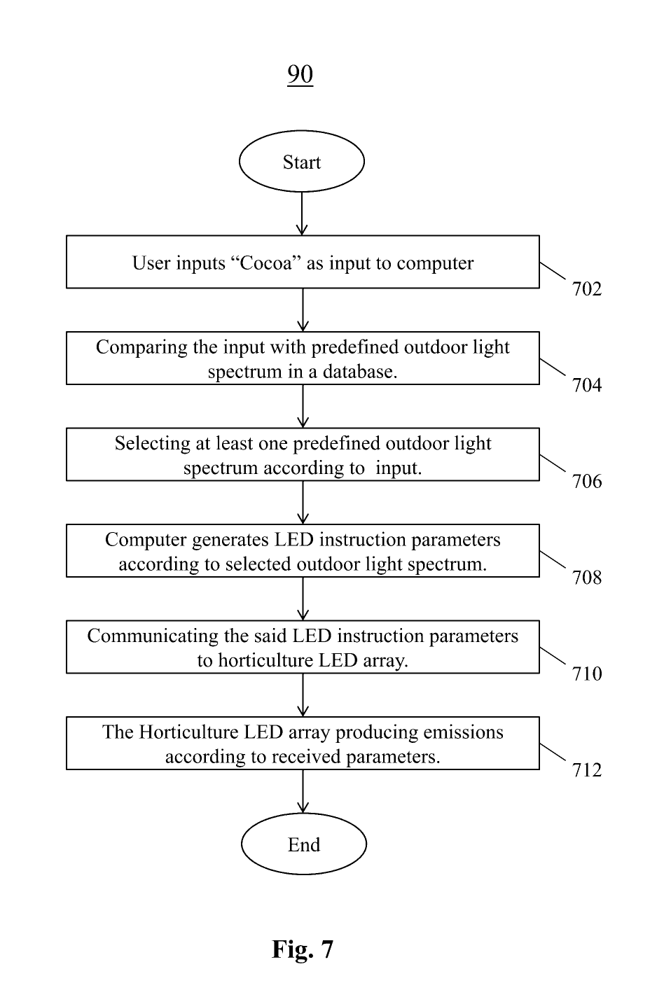

In embodiment 90 of the present invention, FIG. 7 illustrates an exemplary method of the working of the invention for a layman. At step 702 the user inputs “cocoa” and the succeeding procedure is same as that described for FIG. 2. The plant specific data utilized now relates to the cocoa plants. The cloud network or database can now make a default assumption that atmospheric conditions relate to locations where cocoa is known to be farmed successfully. The atmospheric data relates now to e.g. Ghana or equatorial regions, i.e. thin air columns during noon Earth and tropical temperatures.

It should be noted that any features of the embodiment 90 may be readily combined or permuted with any of the embodiments 10, 20, 30, 40, 50, 60, 70, 80, 91, 92 and/or 93 in accordance with the invention.

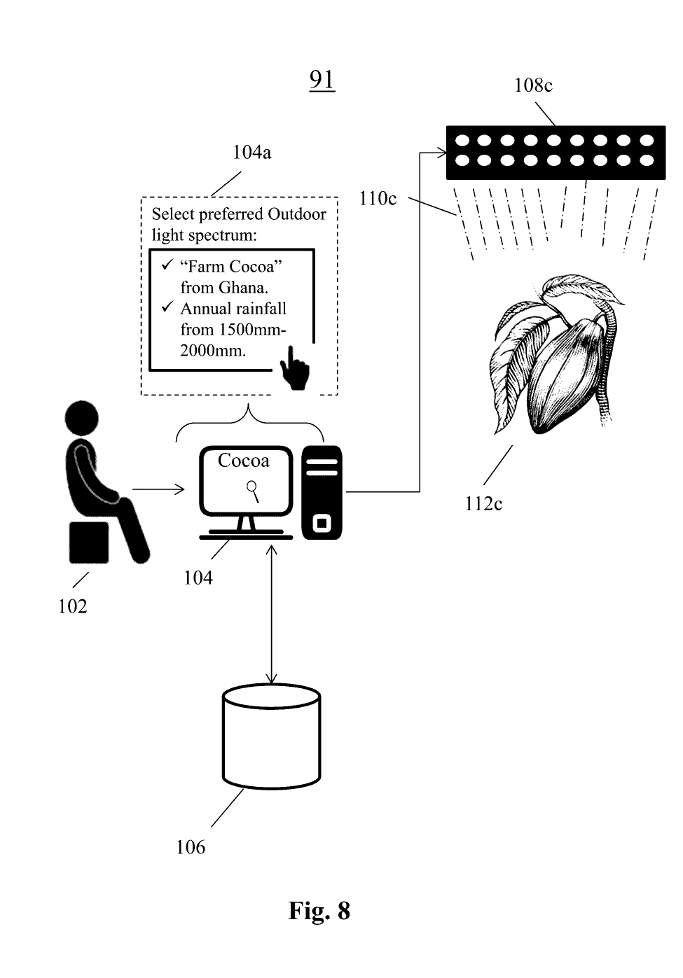

In embodiment 91 of the present invention, illustrated in FIG. 8, the process as disclosed for FIGS. 4 and 6 can be repeated considering the plant name as “Cocoa” and the plant 112c would be provided with “natural light from Ghana” as horticultural light 110c. This especially is helpful for a user 102 who wants to grow “cocoa” but does not know of the climatic conditions the plant is grown in. The user 102 is provided with a list of preferred outdoor light spectrum on UI 104a, or the computer makes a direct automatic selection. The selection of the preferred spectrum would then command the computer 104 to generate LED instructions parameters for LED array 108c.

It should be noted that any features of the embodiment 91 may be readily combined or permuted with any of the embodiments 10, 20, 30, 40, 50, 60, 70, 80, 90, 92 and/or 93 in accordance with the invention.

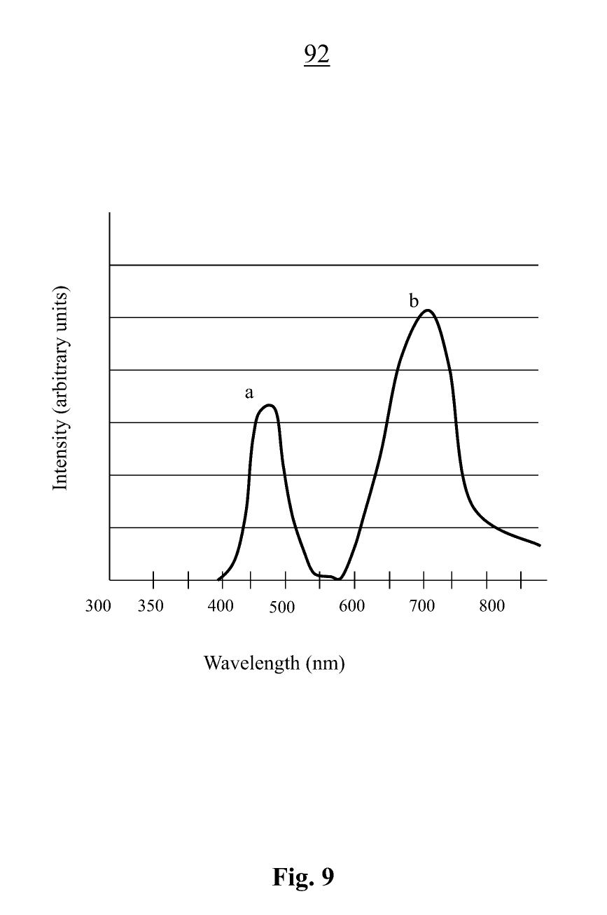

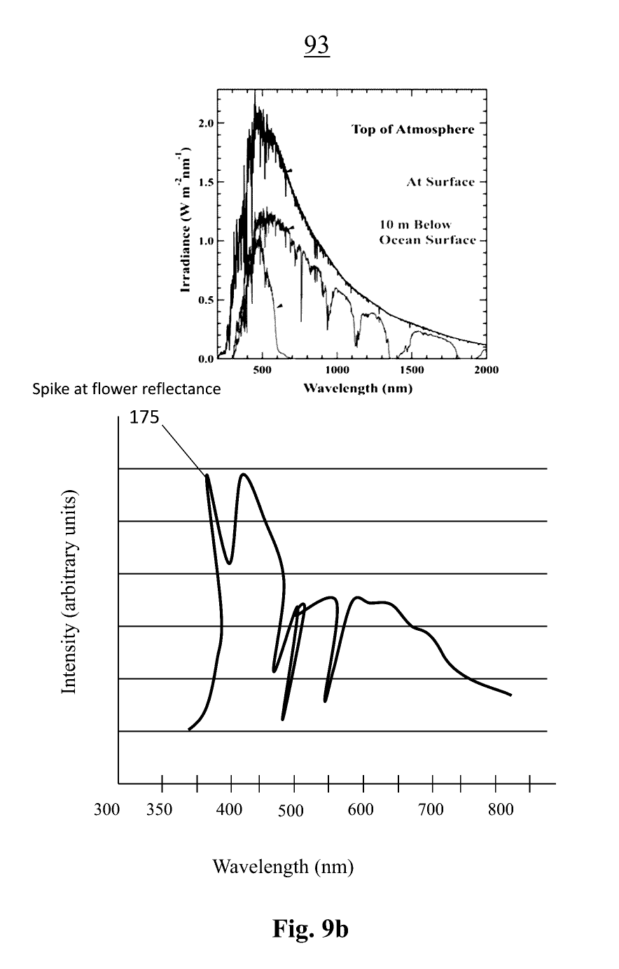

According to embodiment 92 of the present invention, as illustrated in FIG. 9, a very artificial spectrum of light emitted by the LED array is shown. The LED array is being controlled by the computer and according to preference of the user emits lights in the range 300-800 nm for minimum power consumption and maximum growth. This spectrum is not encountered in the outdoors on planet Earth—Along the y-axis is the intensity and wavelength is measured in nanometers along x-axis.

Only a part of the electromagnetic spectrum is utilized by the plants for the process of photosynthesis. Hence, only such spectrum is required to be emitted by the LED array onto the plants for their growth.

A spectral characteristic with a couple peaks namely “a” and “b” in the wavelength range from 440 to 500 nm and 600 to 700 nm respectively and arranged to exhibit a full width of half maximum of at least 50 nm or more, are emitted by the LED array. Further, a spectral characteristic in the wavelength range from 500 to 600 nm is arranged to be minimized and/or omitted and/or to be reduced below the intensity in 400-500 nm band and below the intensity in 600-700 nm band. This spectrum addresses the chlorophyll and betacarotene receptors of plants that have absorptions at the earlier mentioned emission peaks.

It should be noted that any features of the embodiment 92 may be readily combined or permuted with any of the embodiments 10, 20, 30, 40, 50, 60, 70, 80, 90, 91 and/or 93 in accordance with the invention.

FIG. 9b shows an exemplary artificial outdoor light spectrum embodiment 93. The Top diagram shows the solar irradiances at the top of the atmosphere, at the surface of the Earth and 10 m below the Ocean surface. Quite clearly, the effect of the fluid column through which light passes is remarkable. The lower diagram shows a computer generated outdoor light spectral model, for a plant that is at the Earth surface, quite close to the sea surface, i.e. not in a high altitude location. To this spectrum a spike 175 has been added at the flower reflectance maximum of the plant. This peak will make the flowers more visible to insects that pollinate the plants in the growth chamber or greenhouse.

It should be noted that any features of the embodiment 93 may be readily combined or permuted with any of the embodiments 10, 20, 30, 40, 50, 60, 70, 80, 90, 91 and/or 92 in accordance with the invention.

In all of the aforementioned embodiments 10, 20, 30, 40, 50, 60, 70, 80, 90, 91, 92 and/or 93 it is also possible to vary the intensity and the spectrum of the simulated outdoor light for horticulture according to the time of day and weather. Some plants may benefit more from dawn or dusk light, and accordingly the inventive system and method can administer more dawn or dusk light to these plants than normally would occur in natural outdoor conditions. Similarly some plants may benefit from light associated with e.g. cloudy weather, and accordingly the inventive system and method can administer more of this light than in normal natural outdoor growing conditions would occur. Usually the aggregate intensity of the horticultural light produced by the simulated outdoor light spectrum matches the intensity encountered outdoors in the conditions being simulated. Naturally the aggregate intensity can be very different, depending on the conditions being simulated. For example a cloudy dawn would have an intensity that would be considerably less compared to clear sky conditions at noon in some embodiments of the invention. However, it is also possible that the system and method of the invention produces a fraction or a multiple of the aggregate intensity of the model spectrum, usually by keeping the spectral proportions constant. However, adjustments to the aggregate emission intensity of horticultural light, and to the spectral proportions, may in some embodiments be inputted into the system manually by the user in accordance with the invention.

The invention has been explained above with reference to the aforementioned embodiments and several commercial and industrial advantages have been demonstrated. The methods and arrangements of the invention allow farmers to convert their everyday knowledge into actionable scientific and quantitative plant growth data that can be used to generate known preferential plant growth conditions from a specific geography to a dark growth chamber or a greenhouse anywhere in the world.

The invention has been explained above with reference to the aforementioned embodiments. However, it is clear that the invention is not only restricted to these embodiments, but comprises all possible embodiments within the spirit and scope of the inventive thought and the following patent claims.

### REFERENCES

U.S. Pat. No. 8,850,743, “Lighting assembly”, Lars AIKALA, 2014.

WO 2012123627 A1, “Plant illumination device and method”, Lars Aikala et al., 2012.

WO 2014013400 A2, “Method for providing horticulture light to a crop and lighting device for horticulture lighting”, Marcellinus Petrus Carolus Michael Krijn et al, 2014.

EP2604094, “OPTOELECTRONIC DEVICE, SYSTEM AND METHOD FOR OBTAINING AN AMBIENT LIGHT SPECTRUM AND MODIFYING AN EMITTED LIGHT, Carreras Molins, Josep Maria, 2014.

What is claimed is:

1. A method for providing horticultural light to a plant, said method comprising at least one computer, at least one database, a communication network and a horticultural light emitting diode (LED) array configured to provide light to plants, characterised by the steps of:
user defines at least one attribute to at least one computer;
at least one computer accesses the database to identify an outdoor light spectrum corresponding to the said attributes;
at least one computer determines LED instruction parameters corresponding to the identified outdoor light spectrum;
at least one computer communicates the said LED instruction parameters to the horticultural LED array;
the horticultural LED array receives said instruction parameters and produces emission corresponding to the said outdoor light spectrum;
the said outdoor light spectrum produced by the said horticultural LED array shines on at least one plant.

2. The method as claimed in claim 1, characterised in that, the at least one attribute may be any one of the following:
at least one of a plurality of outdoor light attributes, a plant name, pollinating insect species, and/or at least one geographical location of a plant.

3. The method as claimed in claim 2, characterised in that, the outdoor light attributes may include any of the following: air humidity, cloud coverage, temperature, visibility, fog particle size, time of day, time of year and/or any celestial mechanical condition associated with the location of at least one plant.

4. The method as claimed in claim 1, characterised in that, based on said at least one attribute, the computer computes a model atmosphere and combines said model atmosphere with a solar emission model to determine the said outdoor light spectrum.

5. The method as claimed in claim 2, characterised in that, at least one outdoor light spectrum includes insect pollination enhancing spectral features, and said method may produce a plurality of outdoor light spectra that enhance pollination with different insect species.

6. The method as claimed in claim 1, characterised in that, said horticultural LED array comprises at least one LED having:
a spectral characteristic with a peak in the wavelength range from 600 to 700 nanometer (nm) and arranged to exhibit a full width of half maximum of at least 50 nm or more;
a spectral characteristic with a peak in the wavelength range from 440 to 500 nm and arranged to exhibit a full width of half maximum of at least 50 nm or more; and
a spectral characteristic in the wavelength range from 500 to 600 nm is arranged to be minimized and/or omitted and/or to be reduced below the intensity in 400-500 nm band and below the intensity in 600-700 nm band.

7. The method as claimed in claim 1, characterised in that, at least one database is a HITRAN database, a SQL (Structured Query Language) database, a relational database, and/or astronomy database.

8. The method as claimed in claim 1, characterised in that, the computer determines watering and mineral dose for a plant based on the at least one attribute defined by the user, and the said computer generates a control signal to a system such that the system provides necessary water and mineral to the said plant.

9. A system for providing horticultural light to a plant, said system comprises:
at least one computer having a user interface with which a user is arranged to define at least one attribute to the at least one computer;
at least one database accessible by the said at least one computer, the at least one computer is configured to identify an outdoor light spectrum corresponding to the said plurality of attributes as defined by the user;
an instruction module having a plurality of light emitting diode (LED) instruction parameters corresponding to the identified outdoor light spectrum, and the at least one computer is configured to select the said LED instruction parameters;
a horticultural light emitting diode (LED) array configured to provide light to at least one plant,
the horticultural LED array is configured to receive said LED instruction parameters and produce emission corresponding the said outdoor light spectrum, wherein the said horticultural LED array is configured to shine light on at least one plant and the spectrum of the light is configured as the said outdoor light spectrum.

10. The system as claimed in claim 9, characterised in that, the at least one attribute is any of the following: at least one of a plurality of outdoor light attributes, a plant name, and/or at least one geographical location of a plant.

11. The system as claimed in claim 10, characterised in that, the outdoor light attributes may include any of the following: air humidity, cloud coverage, temperature, visibility, fog particle size, time of day, time of year and/or any celestial mechanical condition associated with the location of at least one plant.

12. The system as claimed in claim 9, characterised in that, the computer is configured to compute a model atmosphere based on at least one attribute defined by the user and configured to combine said model atmosphere with a solar emission model to determine the said outdoor light spectrum.

13. The system as claimed in claim 9 further comprises a communication network, characterised in that, the said computer is configured to communicate the said LED instruction parameters of the instruction module to the horticultural LED array via the said communication network.

14. The system as claimed in claim 9, characterised in that, said database is a HITRAN database, a SQL (Structured Query Language) database, a relational database, and/or astronomy database.

15. The system as claimed in claim 9, characterised in that, said horticultural LED array is configured to comprise at least one LED having:
a spectral characteristic with a peak in the wavelength range from 600 to 700 nanometer (nm) and arranged to exhibit a full width of half maximum of at least 50 nm or more;
a spectral characteristic with a peak in the wavelength range from 440 to 500 nm and arranged to exhibit a full width of half maximum of at least 50 nm or more; and
a spectral characteristic in the wavelength range from 500 to 600 nm is arranged to be minimized and/or omitted and/or to be reduced below the intensity in 400-500 nm band and below the intensity in 600-700 nm band.

16. The system as claimed in claim 9, characterised in that, at least one outdoor light spectrum is configured to include insect pollination enhancing spectral features, and said system is adapted to produce a plurality of outdoor light spectra that enhance insect pollination with different insect species.

17. The system as claimed in claim 9, characterised in that, the computer is adapted to determine watering and mineral dose of a plant based on the at least one attribute, and the said computer generates a control signal to a system such that the system is configured to provide the necessary water and mineral to the said plant.

18. A software program product adapted to execute a method in a system, the said software program product being configured to control horticultural light administered to a plant by the steps of:
user provides an input to at least one computer;
accessing at least one database having at least one predefined outdoor light spectra, and/or algorithms for producing at least one outdoor light spectra, via a computer;
comparing the said input with the plurality of predefined or derived outdoor light spectra;
identifying at least one of predefined or derived outdoor light spectrum, the said spectrum corresponds to spectrum derived based on the input of the user;
selecting a plurality of light emitting diode (LED) instruction parameters,
the said LED instruction parameters being configured to produce a corresponding emission spectrum to the identified outdoor light spectrum;
transmitting the said LED instruction parameters to a horticultural light emitting diode (LED) array;
producing emission from the horticultural LED array based on the received LED instruction parameters, the said emission correspond to the said outdoor light spectrum.

19. The software program product as claimed in claim 18, characterised in that, the input may comprise any of the following: a outdoor light attribute, a plant name, or at least one geographical location of a plant.

20. The software program product as claimed in claim 19, characterised in that, the outdoor light attributes may include any of the following: air humidity, cloud coverage, temperature, visibility, fog particle size, time of day, time of year and/or any celestial mechanical condition associated with the location of at least one plant.

21. The software program product as claimed in claim 18, characterised in that, based on said input, the computer computes a model atmosphere and combines said model atmosphere with a solar emission model to determine the said outdoor light spectrum.

22. The software program product as claimed in claim 18, characterised in that, said horticultural LED array comprises at least one LED having:
a spectral characteristic with a peak in the wavelength range from 600 to 700 nm and arranged to exhibit a full width of half maximum of at least 50 nm or more;
a spectral characteristic with a peak in the wavelength range from 440 to 500 nm and arranged to exhibit a full width of half maximum of at least 50 nm or more; and
a spectral characteristic in the wavelength range from 500 to 600 nm is arranged to be minimized and/or omitted and/or to be reduced below the intensity in 400-500 nm band and below the intensity in 600-700 nm band.

23. The software program product as claimed in claim 18, characterised in that, at least one outdoor light spectrum includes insect pollination enhancing spectral features, and said method may produce a plurality of outdoor light spectra that include insect pollination enhancing spectral features.

24. The software program product as claimed in claim 18, characterised in that, said database is a HITRAN database, a SQL (Structured Query Language) database, a relational database, and/or astronomy database.

25. The software program product as claimed in claim 18, characterised in that, a watering and mineral dose of a plant is determined by the computer, and the said computer generates a control signal to a system such that the system provides necessary water and mineral to the said plant.
